(19) United States
(12) Patent Application Publication
(10) Pub. No.: US 2026/0257682 A1
(43) Pub. Date: Sep. 3, 2026

(54) Method and Device for Accelerating a Vehicle at a Signaling Unit

(71) Applicant: Bayerische Motoren Werke Aktiengesellschaft, Muenchen (DE)

(72) Inventor: Robert KNORRN, Frankfurt am Main (DE)

(21) Appl. No.: 18/993,342

(22) PCT Filed: Jul. 7, 2023
(86) PCT No.: PCT/EP2023/068906

§ 371 Date: Jan. 10, 2025

(30) Foreign Application Priority Data
Jul. 12, 2022 (DE) 10 2022 117 318.6

(51) Int. Cl. B60W 30/18; B60W 30/14; B60W 50/14

(52) U.S. Cl. CPC B60W 30/18154; B60W 30/143; B60W 50/14; B60W 2520/10; B60W 2540/215; B60W 2720/106

(57) ABSTRACT

A device for accelerating a vehicle as part of a speed control process during a journey towards an upcoming signaling unit is described. The device is configured to determine that, during the journey towards the upcoming signaling unit, the actual driving speed of the vehicle is below the target driving speed of the speed control process. The device is also configured to determine distance information relating to the distance between the upcoming signaling unit and the vehicle and, as part of the process of controlling the speed to the target driving speed, to cause an acceleration of the vehicle with an acceleration value that depends on the distance information.

### BACKGROUND AND SUMMARY

The invention relates to a device and a corresponding method for operating a driving function of a vehicle, in particular a speed control of the vehicle, at a signaling unit.

A vehicle can have one or more driving functions that support the driver of the vehicle in driving the vehicle, in particular in the case of longitudinal and/or lateral guidance. An exemplary driving function for supporting the longitudinal guidance of a vehicle is the Adaptive Cruise Control (ACC) function, which can be used to drive the vehicle longitudinally with a defined set or target speed and/or at a defined set or target distance from a vehicle traveling in front of the vehicle. The driving function can also be used in conjunction with a signaling unit (in particular with a traffic light) at a traffic junction (such as at an intersection) in order to enable automated longitudinal guidance, such as an automated deceleration, at the signaling unit.

This document addresses the technical problem of increasing the comfort of a driving function for the automated longitudinal guidance of a vehicle at a signaling unit in a safe manner.

The problem is solved by each of the independent claims. Advantageous embodiments are described, inter alia, in the dependent claims. It should be noted that additional features of a claim dependent on an independent claim without the features of the independent claim or only in combination with a subset of the features of the independent claim can form, independently of the combination of all features of the independent claim, a separate invention which can be made the subject of an independent claim, a divisional application or a subsequent application. This applies in the same way to technical teachings described in the description, which can form an invention independent of the features of the independent claims.

According to one aspect, a device is described for accelerating a (motor) vehicle as part of a speed control when traveling towards an upcoming signaling unit (e.g., a light signal system, such as a traffic light, or a road sign). The speed control can be part of a driving function, in particular an ACC driving function. The speed control can be initiated when the vehicle is traveling freely (without being directly at the vehicle in front). The driving speed can be controlled to a target driving speed (defined by the user of the vehicle).

In particular, the signaling unit can comprise a traffic light. The device can be configured to change the signaling unit, in particular the signaling state (e.g., the color) of the signaling unit, during the automated longitudinal guidance of the vehicle. Depending on the signaling state of the signaling unit, the device can be configured, for example, to cause the vehicle to be automatically longitudinally guided past the signaling unit at the target speed based on the speed control (if the signaling state (e.g., green) indicates that the vehicle may travel freely at the junction). On the other hand, the device can be configured to automatically slow the vehicle to a standstill at the stop position of the signaling unit (if the signaling state (e.g., yellow or red) indicates that the vehicle must stop at the signaling unit).

The device is configured to determine that, when driving towards the upcoming signaling unit, the actual driving speed of the vehicle is below the target driving speed of the speed control (e.g., 10% or more below the target speed). Such a situation can occur when the speed control is activated. As part of the speed control, acceleration is typically effected with a certain standard value in order to adjust, in particular to control, the speed of the vehicle to the target speed. The standard value can depend on the difference between the actual driving speed and the target driving speed (and typically increases as the difference increases).

It is therefore possible, especially with a relatively high difference between actual driving speed and target driving speed, to have a relatively severe acceleration of the vehicle, which may be perceived as uncomfortable by the user of the vehicle when driving towards the upcoming signaling unit (especially if the signaling unit is not far away from the vehicle).

The device is also configured to determine distance information in relation to the (temporal and/or spatial) distance between the upcoming signaling unit and the vehicle. In particular, the distance can be determined in seconds of driving time and/or in meters of driving distance.

The distance information can be determined based on sensor data from one or more environment sensors (e.g., a camera and/or a lidar sensor) of the vehicle and/or on the basis of a digital map for the road network traveled by the vehicle. This data can also be used to recognize the upcoming signaling unit.

The device is also configured, as part of the speed control, to accelerate the vehicle to the target driving speed with an acceleration value that depends on the distance information. In other words, a speed control can still be performed at the (set) target speed. However, the acceleration used as part of the speed control and/or the maximum acceleration permissible as part of the speed control may depend on the distance information.

The acceleration value of the acceleration can be increased with increasing distance and/or reduced with decreasing distance. The device can be configured, for example, to determine based on the distance information that the distance is equal to or less than a (predefined) distance threshold value. In response to the determination, the acceleration value can be reduced compared to the standard acceleration value used as part of the speed control.

The acceleration used in the context of free travel as part of the speed control can thus be set as a function of the (temporal and/or spatial) distance to an upcoming signaling unit. This can increase comfort for the user (especially when the speed control is activated).

The acceleration used as part of the speed control (which, e.g., represents a controlled variable of the speed control loop) can be set depending on a control error, wherein the control error can depend on the difference between the actual driving speed and the target driving speed or can correspond to the difference. The speed controller can be used to set the acceleration value of the vehicle as controlled variable. The value of the acceleration typically depends on the control error and typically increases as the control error increases.

As part of the speed control, a maximum value of the acceleration can be defined, so that this maximum value cannot be exceeded (not even in the event of a relatively large control error). During normal operation of the speed controller, the maximum value can correspond to a certain standard maximum value.

The device can be configured to define and/or set the maximum acceleration value of the vehicle used as part of the speed control as a function of the distance information, in such a way that the maximum acceleration value increases with increasing distance and/or decreases with decreasing distance. For example, the device can be configured to determine, based on the distance information, that the distance is equal to or less than a (predefined) distance threshold value. In response to the determination, a reduced maximum acceleration value compared to the standard maximum acceleration value used as part of the speed control can be used.

The selective reduction of the maximum acceleration value of the vehicle permissible as part of the speed control as a function of the distance information makes it possible to provide a particularly comfortable driving function when approaching a signaling unit.

The device can be configured to determine that the actual driving speed is below the target driving speed due to activation of the speed control.

For example, a user input from a user of the vehicle can be detected at the user interface of the vehicle to the effect that the speed control should be activated (at a certain starting position). It can then be reliably determined based on the detected user input that the actual driving speed is below the target driving speed on account of activation of the speed control.

Alternatively or additionally, the device can be configured to determine that the vehicle (at the starting position) has switched from traveling behind with a distance control to a vehicle in front to traveling freely with a speed control (e.g., because the vehicle in front has left the lane on which the vehicle is traveling). This can be detected based on the sensor data from one or more environment sensors. Based on the detected transition from the distance control to the speed control, it can then be determined that the actual driving speed is below the target driving speed due to activation of the speed control.

The acceleration value of the acceleration of the vehicle can, if necessary only then, be ascertained as a function of the distance information if it has been determined that the actual driving speed is below the target driving speed due to an activation of the speed control. The distance-dependent setting of the acceleration value of the speed control can therefore be limited to the speed control activation phase. In this way, the comfort for the user can be further increased.

The device can be configured to determine whether the speed control (or the driving function) is operated in an automatic mode in which the upcoming signaling unit is automatically taken into account when the vehicle is longitudinally guided, or is operated in a manual mode in which the upcoming signaling unit is only taken into account when the vehicle is longitudinally guided after an offer has been accepted by a user of the vehicle.

For example, the device can be configured (in the manual mode) to output an offer to the user of the vehicle via the user interface of the vehicle to the effect that the upcoming signaling unit, in particular the signaling state of the upcoming signaling unit, should be changed as part of the speed control of the vehicle. The user then has the option of accepting or rejecting the offer via a user input. On the other hand, in automatic mode, the signaling unit can be considered automatically without feedback from the user.

The device described in this document can thus be configured to adjust the acceleration value of the acceleration used as part of the speed control as a function of the distance information to an upcoming signaling unit even if the signaling unit is not yet involved in the automated longitudinal guidance of the vehicle. This allows the user to extend the period of time during which the offer to take into account the signaling unit can be accepted. This can thus increase the comfort of the driving function.

As already explained above, the speed control described in this document can be implemented as part of a driving function that is designed to automatically longitudinally guide the vehicle at a and/or in conjunction with a signaling unit. The driving function can be designed according to SAE level 2. In other words, the driving function may provide automated driving and/or driver assistance (with regard to longitudinal guidance) according to SAE level 2. The driving function can be limited to the longitudinal guidance of the vehicle. During operation of the driving function, the lateral guidance of the vehicle can optionally be provided manually by the driver or by an additional and/or separate driving function (e.g., by a lane departure warning system).

As part of the driving function, the vehicle can be automatically longitudinally guided in accordance with the set or target speed and/or in accordance with the set or target distance to a front vehicle travelling (directly) in front of the vehicle. For this purpose, the driving function can provide the speed controller described in this document, by which the actual driving speed of the vehicle is set, in particular controlled, according to the set or target speed. Alternatively or additionally, a distance controller can be provided, by which the actual distance of the vehicle to the vehicle in front is set, in particular controlled, according to the set or target distance. If there is no relevant vehicle in front or if the vehicle in front is traveling faster than the set or target speed, the driving speed of the vehicle can be controlled. Alternatively or additionally, if the vehicle in front is traveling slower than the set or target speed, the distance between the vehicle and the vehicle in front can be controlled. The driving function can thus be configured to provide an Adaptive Cruise Control (ACC) driver assistance function.

The vehicle may comprise a user interface for interaction with a user, in particular with the driver, of the vehicle. The user interface may include one or more control elements that allow the user to define the set and/or target speed and/or the set and/or target distance. Alternatively or additionally, the one or more control elements can enable the user to confirm a previously determined set and/or target speed and/or a previously determined set and/or target distance of the vehicle for the operation of the driving function. The one or more control elements can be designed to be operated with a hand and/or a finger of the driver. Alternatively or additionally, the one or more control elements can be arranged on a steering means (in particular on a steering wheel or on a steering yoke) of the vehicle.

Furthermore, the driving function can be configured to consider one or more signaling units on the roadway (in particular road) and/or route travelled by the vehicle during the automated longitudinal guidance. A signaling unit can be provided to define the right of way at a junction (in particular at an intersection) of the road network used by the vehicle. The definition of the right of way can be variable in time (e.g., in the case of a light signal system, such as a traffic light system, with one or more different signal groups (each with one or more signal emitters) for one or more different directions of travel of the vehicle at the junction) or fixed (such as in the case of a road sign, e.g., a stop sign).

During operation of the driving function, data relating to a signaling unit arranged ahead (at a junction) in the vehicle's direction of travel can be determined. The data can be map data in relation to signaling units and/or junctions in the road network used by the vehicle. The map data (i.e., the digital map) may comprise one or more attributes for the individual signaling units. The one or more attributes for a signaling unit can display or include:
the type of signaling unit, in particular a light signal system or a road sign; and/or
the number of different signal groups (and the number of signal emitters per signal group) of the signaling unit for different directions of travel and/or for different lanes at the junction of the roadway network at which the signaling unit is arranged or with which the signaling unit is associated; and/or
the position (e.g., the GPS coordinates) of the signaling unit and/or the stop line of the signaling unit within the roadway network; and/or
the relative distance of the stop line to the associated signaling unit; and/or
the relative distance and/or the relative arrangement of the individual signal emitters of the signaling unit to each other.

The driving function can be configured using a position sensor (e.g., a GPS or GNSS receiver) of the vehicle and/or using odometry to determine the actual position (e.g., the current GPS or GNSS coordinates) of the vehicle within the road network. The map data can then be used to identify a (e.g., the next) signaling unit on the vehicle's route or on the approach to a junction ahead. Furthermore, one or more map attributes can be determined in relation to the identified signaling unit.

Alternatively or in addition, the data relating to an upcoming, in the direction of travel of the vehicle, signaling unit (at a junction) may comprise environment data relating to the signaling unit, or may be determined based on environment data. The environment data can be detected by one or more of the vehicle's environment sensors. Exemplary environment sensors are a camera, a radar sensor, a lidar sensor, etc. The one or more environment data items can be configured to detect sensor data (i.e., environment data) in relation to the environment in front of the vehicle in the direction of travel.

The driving function can be configured to detect that a signaling unit is arranged in front of the vehicle in the direction of travel based on the environment data (in particular based on the sensor data of a camera). For this purpose, for example, an image analysis algorithm can be used. Furthermore, the driving function can be configured to determine the type of signaling unit (e.g., light signal system or road sign) based on the environment data. Furthermore, the driving function can be configured, based on the environment data, to determine the (signaling) state of the signaling unit in relation to the permission to drive over the junction associated with the signaling unit. In particular, the colors (green, yellow or red) of the one or more signal groups of a light signal system can be determined.

The driving function can be configured to take an identified signaling unit into account during the automated guidance of the vehicle. In particular, the driving function can be configured to determine, on the basis of the data relating to the recognized signaling unit, in particular on the basis of the color of a light signal or a signal group of the signaling unit displayed by the data, whether the vehicle must stop or does not have to stop at the signaling unit, in particular at the stop position of the signaling unit. For example, it can be identified that the vehicle must stop because the signal group relevant for the vehicle is red. Alternatively, it can be identified that the vehicle does not have to stop because the signal group relevant for the vehicle is green. In another example, it can be recognized that the vehicle must stop because the signaling unit is a stop sign.

The driving function can also be configured to cause the vehicle to stop automatically at the identified signaling unit if it is determined that the vehicle must stop at the signaling unit. For this purpose, an automated deceleration process (to a standstill) can be carried out. The vehicle can be automatically driven up to or just in front of the stopping position of the signaling unit. During the automated deceleration process, one or more wheel brakes (e.g., one or more friction brakes or one or more recuperative brakes) can be activated automatically by the driving function in order to slow the vehicle down (to a standstill). The timing of the effected deceleration can depend on the available braking distance to the identified signaling unit.

Alternatively or additionally, the driving function can be configured to cause the vehicle to be automatically longitudinally guided past the identified signaling unit, in particular via the stopping position of the signaling unit, if it is determined that the vehicle does not have to stop at the signaling unit. The speed and/or distance control can be continued according to the set or target speed and/or according to the set or target distance to the vehicle in front.

The driving function can thus be configured to provide an ACC driving function under consideration of signaling units. The driving function is also referred to in this document as the Urban Cruise Control (UCC) driving function.

The term “automated driving” can be used in the context of the document to describe a driving with automated longitudinal or lateral guidance or autonomous driving with automated longitudinal and lateral guidance. Automated driving can, for example, involve driving on the highway for a longer period of time or driving for a limited period of time when parking or maneuvering. The term “automated driving” comprises automated driving with any degree of automation. Examples of degrees of automation are assisted, partially automated, highly automated or fully automated driving. These degrees of automation have been defined by the Federal Highway Research Institute (BASt) (see BASt publication “Forschung kompakt”, issue November 2012). In the case of assisted driving, the driver performs the longitudinal or lateral guidance permanently, while the system takes over the other function within certain limits. In semi-automated driving (SAD), the system takes over the longitudinal and lateral guidance for a certain period of time and/or in specific situations, wherein the driver continuously must permanently monitor the system as in assisted driving. In highly automated driving (HAD), the system takes over longitudinal and lateral guidance for a certain period of time without the driver having to permanently monitor the system; however, the driver must be able to take over vehicle guidance within a certain period of time. In fully automated driving (FAD), the system can, for a specific application case, automatically manage the driving in all situations; for this application case the driver is no longer required. The four levels of automation mentioned above correspond to SAE levels 1 to 4 of the SAE J3016 standard (SAE—Society of Automotive Engineering). For example, highly automated driving (HAD) corresponds to level 3 of the SAE J3016 standard. SAE J3016 also provides for SAE level 5 as the highest degree of automation, which is not included in the BASt definition. SAE level 5corresponds to driverless driving, in which the system can automatically handle all situations like a human driver during the entire journey; a driver is generally no longer required. The aspects described in this document relate in particular to a driving function or a driver assistance function that are designed in accordance with SAE level 2.

According to a further aspect, a (road) motor vehicle (in particular a passenger car or a truck or a bus or a motorcycle) is described which comprises the device described in this document.

According to a further aspect, a method for accelerating a vehicle as part of a speed control when traveling towards an upcoming signaling unit is described. The method comprises the step of determining that, when traveling towards the upcoming signaling unit, the actual driving speed of the vehicle is below the target driving speed of the speed control (and that this speed difference is due to a brief activation of the speed control).

The method further comprises a step of ascertaining distance information with respect to the distance of the upcoming signaling unit from the vehicle, and effecting acceleration of the vehicle within the speed control to the target vehicle speed (defined by the user of the vehicle) with an acceleration value dependent on the distance information.

According to a further aspect, a software (SW) program is described. The SW program can be configured to be executed on a processor (e.g., on a control unit of a vehicle), and thereby to execute the method described in this document.

According to a further aspect, a storage medium is described. The storage medium may comprise an SW program configured to be executed on a processor and thereby to perform the method described in this document.

It should be noted that the methods, devices and systems described in this document may be used alone or in combination with other methods, devices and systems described in this document. Furthermore, any aspects of the methods, devices and systems described in this document can be combined with each other in a variety of ways. In particular, the features of the claims can be combined with each other in a variety of ways. Furthermore, features listed between parentheses are to be understood as optional features.

In the following, the invention is described in greater detail based on exemplary embodiments, in which

### BRIEF DESCRIPTION OF THE DRAWINGS

FIG. 1 shows exemplary components of a vehicle;

FIG. 2a shows an exemplary traffic light system;

FIG. 2b shows an exemplary road sign;

FIG. 3a shows an exemplary driving situation;

FIG. 3b shows exemplary speed curves of the vehicle in the driving situation shown in FIG. 3a; and

FIG. 4 shows a flow chart of an exemplary method for accelerating a vehicle at a signaling unit.

### DETAILED DESCRIPTION OF THE DRAWINGS

As stated at the outset, the present document deals with increasing the comfort of a driving function, in particular a driver assistance system, of a vehicle in conjunction with a signaling unit at a junction of the roadway used by the vehicle. In particular, the present document deals with enabling a convenient and safe speed control at a signaling unit.

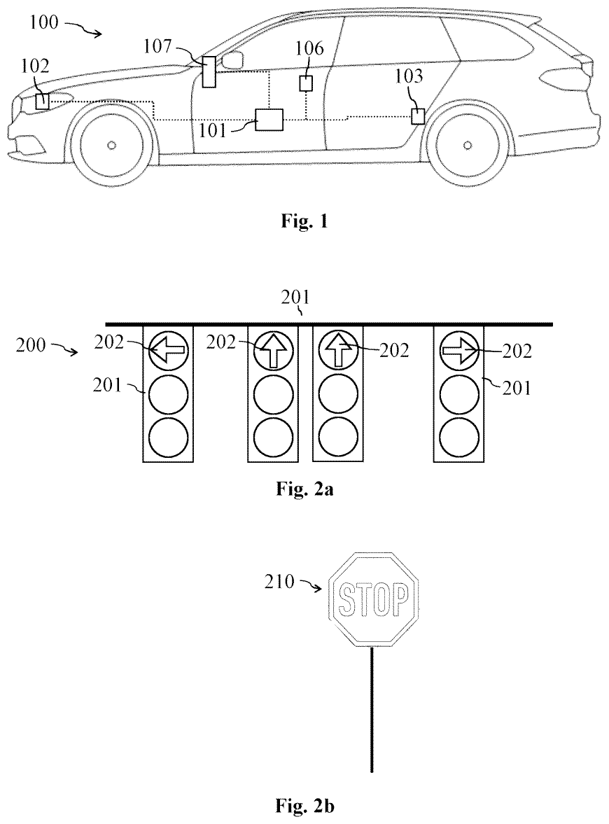

FIG. 1 shows exemplary components of a vehicle 100. The vehicle 100 comprises one or more environment sensors 102 (e.g., one or more image cameras, one or more radar sensors, one or more lidar sensors, one or more ultrasonic sensors, etc.), each of which is configured to detect environment data with respect to the environment of the vehicle 100 (with respect to the environment in front of the vehicle 100 in the direction of travel). Furthermore, the vehicle 100 comprises one or more actuators 103, which are configured to react to the longitudinal and/or lateral guidance of the vehicle 100. Exemplary actuators 102 are: a brake system, a drive motor, a steering system, etc.

The (control) device 101 of the vehicle 100 can be configured to recognize, based on the sensor data of the one or more environment sensors 102 (i.e., based on the environment data), to provide a driving function, in particular a driver assistance function. For example, an obstacle on the driving trajectory of the vehicle 100 can be detected based on the sensor data. The device 101 can then control one or more actuators 103 (e.g. the braking system) to automatically decelerate the vehicle 100 and thereby prevent a collision of the vehicle 100 with the obstacle.

As part of the automated longitudinal guidance of a vehicle 100, besides a front vehicle, one or more signaling units (e.g., a light signal system and/or a road sign) can be taken into account on the roadway or road traveled by the vehicle 100. In particular, the signaling state of a light signal or traffic light system can be taken into account, so that the vehicle 100 automatically decelerates to a stopped position at a red traffic light relevant to its own (planned) direction of travel and/or accelerates (again, as appropriate) at a green traffic light.

FIG. 2a shows an exemplary light signal system 200. The light signal system 200 shown in FIG. 2a has four different signal emitters 201, which are arranged at different positions on an approach to an intersection. The left signal emitter 201 has an arrow 202 pointing to the left, thus indicating that this signal emitter 201 is valid for left tums. The two middle signal emitters 201 have an arrow 202 pointing upwards (or no arrow 202) and thus indicate that these two signal emitters 201 apply to travel straight ahead. The individual light signals of these two signal emitters 201 form signal groups. Furthermore, the right signal emitter 201 has an arrow 202 to the right, indicating that this signal emitter 201 is valid for right turns.

FIG. 2b shows an exemplary stop sign as road sign 210, which controls right of way at a traffic junction, in particular at an intersection. The (control) device 101 of the vehicle 100 can be configured to identify, on the basis of the sensor data of the one or more environment sensors 102 (i.e., on the basis of the environment data) and/or on the basis of digital map information (i.e., of map data), a road sign 210 relevant for the journey of the vehicle 100 on the road or roadway traveled by the vehicle 100.

The device 101 of the vehicle 100 may be designed to provide an automated longitudinal guidance of the vehicle 100 in urban areas. This driving function may be referred to as an Urban Cruise Control (UCC) driving function. The driving function can be provided in an automatic mode (aUCC) and/or in a manual mode (mUCC). It may be possible for the driver to specify via the user interface 107 of the vehicle 100 whether the driving function is to be operated in the automatic or in the manual mode.

The device 101 of the vehicle 100 can be configured, on the basis of the environment data of the one or more environment sensors 102 and/or on the basis of map data relating to the road network traveled by the vehicle 100 (in conjunction with the position data of a position sensor 106 of the vehicle 100) to detect an upcoming signaling unit 200, 210 on the route of the vehicle 100. In the manual mode of the UCC driving function, a suggestion or a request can then be output via the user interface 107 as to whether or not the signaling unit 200, 210 should be taken into account in the automated longitudinal guidance of the vehicle 100. The driver of the vehicle 100 can then, for example by operating a control element of the user interface 107, accept or reject or ignore the suggestion. On the other hand, in the automatic mode of the UCC driving function, the detected signaling unit 200, 210 may be automatically (i.e., without any required feedback from the driver) considered in the automated longitudinal guidance of the vehicle 100.

If the detected signaling unit 200, 210 is taken into account during the automated longitudinal guidance of the vehicle 100, then (depending on the type and/or (signaling) state of the signaling unit 200, 210), an automatic deceleration can be effected in order to automatically bring the vehicle 100 to a standstill (e.g. at a red traffic light or at a stop sign). Furthermore (e.g. after a change in the (signaling) state of the signaling unit 200, 210, such as after a change to green), an automatic start of the vehicle 100 can be effected. The vehicle 100 can then be automatically accelerated again to the target speed (considering a defined minimum or target distance to the vehicle in front).

The UCC driving function therefore enables the driver of a vehicle to use the ACC driving function also on a road with one or more signaling units 200, 210 (without having to deactivate and reactivate the ACC function at the individual signaling units 200, 210 in each case).

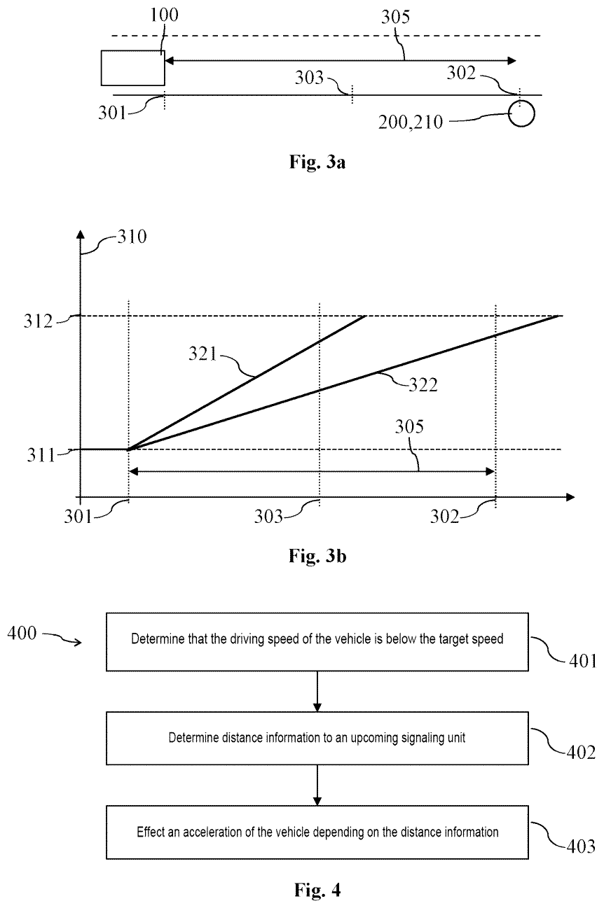

It is possible that the vehicle 100, as shown by way of example in FIGS. 3a and 3b, approaches a signaling unit 200, 210 and has an actual speed 311 which is lower than the target speed 312 of the driving function, although the vehicle 100 is traveling freely. This can occur, for example, if the user of the vehicle 100 activates the driving function while the vehicle 100 is approaching the signaling unit 200 on a roadway 300. Alternatively, such a situation can occur if the vehicle 100 has initially driven behind a (relatively slow-moving) vehicle in front and the vehicle in front has left the road 300 (e.g., has turned onto a driveway).

It can thus be identified by the control device 101 of the vehicle 100 that the vehicle 100 is traveling freely (without a vehicle in front) when the driving function is activated and has an actual speed 311 that is (significantly) lower than the target speed 312 of the speed controller of the driving function. The vehicle 100 could then be accelerated with a (relatively high) standard acceleration of the speed controller to adjust, in particular control, the driving speed 310 of the vehicle 100 to the target speed 312. However, this could lead to a situation in which the vehicle 100 is accelerated with the relatively high standard acceleration even though the vehicle 100 should come to a standstill at the stop position 302 of an upcoming signaling unit 200, 210. This can lead to an uncomfortable situation for the user of the driving function. In particular, the use of a relatively high standard acceleration can reduce the time available for the user of the vehicle 100 to select the signaling unit 200, 210 in manual mode.

The (control) device 101 may be configured to determine distance information relating to the distance 305 between the starting position 301 of the vehicle 100 (when the speed control is activated) and the stop position 302 of the signaling unit 200, 210. The starting position 301 can correspond to the position of the vehicle 100 at which it is identified that a free travel situation of the vehicle 100 exists, and the vehicle 100 should therefore be accelerated to the target speed 312.

The value of the acceleration can then be determined as a function of the distance information. The value of the acceleration can be increased with increasing distance 305. For example, the standard value of the acceleration can be used if the distance 305 is greater than a certain distance threshold value. On the other hand, a reduced acceleration value compared to the standard value can be used if the distance 305 is equal to or smaller than the distance threshold value.

FIG. 3b shows the speed curve 321 of the speed 310 of the vehicle 100 when using the standard acceleration value. Furthermore, FIG. 3b shows the speed curve 322 when using the reduced acceleration value. The reduced acceleration value prolongs the period of time until the vehicle 100 reaches the decision position 303, at which the driver must decide at the latest whether the upcoming signaling unit 200, 210 is to be taken into account or not during operation of the driving function. This can increase comfort for the driver of the vehicle 100.

For example, the vehicle 100 may be driven with the driving function deactivated (in particular with a deactivated distance and/or distance control). The driver of the vehicle 100 is then typically not alerted to an upcoming signaling unit 200, 210. In particular, the upcoming signaling unit 200, 210 is typically not considered in the longitudinal guidance of the vehicle 100.

As soon as the driver activates the driving function, any upcoming signaling unit 200, 210 that should be considered during longitudinal guidance (e.g., due to the signaling state) is identified and/or displayed. The driver then has the option (if the driving function is operated in manual mode) of selecting the identified signaling unit. At the same time, however, an acceleration of the vehicle 100 with the standard value may be implemented to set the vehicle 100 to the target speed 312 for a free travel situation. Depending on the distance 305 and actual driving speed 311 of the vehicle 100, the relatively fast acceleration to the upcoming signaling unit 200, 210 reduces the available time for the driver to accept the driving function offer.

The device 101 described in this document may be configured to perform a dynamic reduction of the vehicle 100 (in comparison to the standard value) in a situation in which the driving function has been activated and a relevant signaling unit 200, 210 has been identified, by means of which reduction a relatively strong acceleration to the set free-travel target speed 312 is avoided. For example, instead of a (maximum possible) standard value of 1 m/s2, an upper acceleration limit of 0.2 m/s2 can be used. With this measure, the driver also has the option, if the signaling unit 200, 210 is relatively close, to accept a manual offer to consider the signaling unit 200, 210 in a timely manner.

FIG. 4 shows a flow chart of a (possibly computer-implemented) method 400 for accelerating a (motor) vehicle 100 as part of a speed control (in particular as part of the UCC driving function) when driving towards an upcoming signaling unit 200, 210.

The method 400 comprises a step of determining 401 that, when traveling to the upcoming signaling unit 200, 210, the actual driving speed 311 of the vehicle 100 is below the target driving speed 312 of the speed control. For example, it can be determined that at an initial position 301 of the vehicle 100, the actual driving speed 311 is lower than the target speed 312. Furthermore, it may be possible to determine, that this speed difference is due to the activation (that occurred at the starting position 301) of the speed control (the UCC driving function).

The method 400 further comprises determining 402 distance information with respect to the distance 305 of the (stop position 302 of the) upcoming signaling unit 200, 210 from the vehicle 100 (from the starting position 301 of the vehicle 100). The distance information can indicate here the temporal and/or the spatial distance 305 (i.e., the driving distance) up to the signaling unit 200, 210. The temporal distance results here from the route and the driving speed 310 of the vehicle 100. The distance information can indicate that the signaling unit 200, 210 is arranged at a distance 305 from the vehicle 100 that is equal to or less than a predefined distance threshold value.

Furthermore, the method 400 comprises a step of effecting 403 an acceleration of the vehicle 100 as part of the speed control to the target driving speed 312 (defined by the user of the vehicle) with an acceleration value, with a maximum possible acceleration value that depends on the distance information. The acceleration value is reduced here with decreasing distance 305 or increased with increasing distance 305.

In other words, it is therefore possible to control the speed of the vehicle 100 to the target speed 312. The difference between the respective actual speed 311 and the target speed 312 can be ascertained as a control error. An acceleration of the vehicle 100 can be effected as a controlled variable. However, the acceleration value of the acceleration can be limited to a value that is dependent on the distance information.

The measures described in this document can safely increase the comfort of a driving function for automated longitudinal guidance at a signaling unit 200, 210.

The present invention is not limited to the exemplary embodiments shown. In particular, it should be noted that the description and the figures are only intended to illustrate, by way of example, the principle of the proposed methods, devices and systems.

1.-11. (canceled)

12. A device for accelerating a vehicle as part of a speed control when traveling towards an upcoming signaling unit, wherein the device is configured to:
determine that, when driving towards the upcoming signaling unit, an actual driving speed of the vehicle is below a target driving speed of the speed control;
determine distance information with respect to a distance of the upcoming signaling unit from the vehicle; and
control, via the speed control, an acceleration of the vehicle to reach the target driving speed based on an acceleration value that depends on the distance information.

13. The device according to claim 12, wherein the device is configured to increase the acceleration value of the acceleration with increasing distance and/or to reduce it with decreasing distance.

14. The device according to claim 12, wherein the device is configured,
based on the distance information, to determine that the distance is equal to or less than a distance threshold value; and
in response to the determination, to effect an acceleration value that is reduced compared to a standard acceleration value used as part of the speed control.

15. The device according to claim 13, wherein the device is configured,
based on the distance information, to determine that the distance is equal to or less than a distance threshold value; and
in response to the determination, to effect an acceleration value that is reduced compared to a standard acceleration value used as part of the speed control.

16. The device according to claim 12, wherein the device is configured to:
determine that the actual driving speed is below the target driving speed due to activation of the speed control; and
determine the acceleration value of the acceleration of the vehicle only in a case in which, as a function of the distance information, it has been determined that the actual driving speed is below the target driving speed due to activation of the speed control.

17. The device according to claim 13, wherein the device is configured to:
determine that the actual driving speed is below the target driving speed due to activation of the speed control; and
determine the acceleration value of the acceleration of the vehicle only in a case in which, as a function of the distance information, it has been determined that the actual driving speed is below the target driving speed due to activation of the speed control.

18. The device according to claim 14, wherein the device is configured to:
determine that the actual driving speed is below the target driving speed due to activation of the speed control; and
determine the acceleration value of the acceleration of the vehicle only in a case in which, as a function of the distance information, it has been determined that the actual driving speed is below the target driving speed due to activation of the speed control.

19. The device according to claim 16, wherein the device is configured to:
detect a user input of a user of the vehicle at a user interface of the vehicle indicating that the speed control is to be activated; and
determine based on the detected user input that the actual driving speed is below the target driving speed due to an activation of the speed control.

20. The device according to claim 17, wherein the device is configured to:
detect a user input of a user of the vehicle at a user interface of the vehicle indicating that the speed control is to be activated; and
determine based on the detected user input that the actual driving speed is below the target driving speed due to an activation of the speed control.

21. The device according to claim 16, wherein the device is configured to:
determine that the vehicle has switched from traveling behind with a distance control to a second vehicle in front to traveling freely with a speed control, in response to a determination that the second vehicle in front has left the lane on which the vehicle is traveling; and
determine based on the detected switch from distance control to speed control that the actual driving speed is below the target driving speed due to activation of the speed control.

22. The device according to claim 19, wherein the device is configured to:
determine that the vehicle has switched from traveling behind with a distance control to a second vehicle in front to traveling freely with a speed control, in response to a determination that the second vehicle in front has left the lane on which the vehicle is traveling; and
determine based on the detected switch from distance control to speed control that the actual driving speed is below the target driving speed due to activation of the speed control.

23. The device according to claim 12, wherein the device is configured to determine a maximum value of the acceleration of the vehicle used as part of the speed control as a function of the distance information, in such a way that the maximum value of the acceleration increases with increasing distance and/or decreases with decreasing distance.

24. The device according to claim 13, wherein the device is configured to determine a maximum value of the acceleration of the vehicle used as part of the speed control as a function of the distance information, in such a way that the maximum value of the acceleration increases with increasing distance and/or decreases with decreasing distance.

25. The device according to claim 12, wherein the device is configured to:
determine whether the speed control is operated in an automatic mode, in which the upcoming signaling unit is automatically considered during the longitudinal guidance of the vehicle, or is operated in a manual mode, in which the upcoming signaling unit is considered in the longitudinal guidance of the vehicle only after an offer has been accepted by a user of the vehicle; and
determine the acceleration value of the acceleration of the vehicle, only in a case in which, as a function of the distance information, the speed control is operated in the manual mode.

26. The device according to claim 13, wherein the device is configured to:
determine whether the speed control is operated in an automatic mode, in which the upcoming signaling unit is automatically considered during the longitudinal guidance of the vehicle, or is operated in a manual mode, in which the upcoming signaling unit is considered in the longitudinal guidance of the vehicle only after an offer has been accepted by a user of the vehicle; and
determine the acceleration value of the acceleration of the vehicle, only in a case in which, as a function of the distance information, the speed control is operated in the manual mode.

27. The device according to claim 12, wherein the device is configured to:
output an offer via a user interface of the vehicle to a user of the vehicle indicating that a signaling state of the upcoming signaling unit is considered as part of the speed control of the vehicle; and
in response to an acceptance of the offer, as a function of the signaling state of the signaling unit, to cause the vehicle to be automatically longitudinally guided past the signaling unit based on the speed control to the target driving speed; or
automatically decelerated until coming to a standstill at a stop position of the signaling unit.

28. The device according to claim 13, wherein the device is configured to:
output an offer via a user interface of the vehicle to a user of the vehicle indicating that a signaling state of the upcoming signaling unit is considered as part of the speed control of the vehicle; and
in response to an acceptance of the offer, as a function of the signaling state of the signaling unit, to cause the vehicle to be
automatically longitudinally guided past the signaling unit based on the speed control to the target driving speed; or
automatically decelerated until coming to a standstill at a stop position of the signaling unit.

29. The device according to claim 12, wherein the device is configured to ascertain the distance information and/or to detect the upcoming signaling unit,
based on sensor data from one or more environment sensors of the vehicle; and/or
based on a digital map for a road network traveled by the vehicle.

30. A method for accelerating a vehicle as part of a speed control when traveling towards an upcoming signaling unit, the method comprising:
determining that, when driving towards the upcoming signaling unit, an actual driving speed of the vehicle is below a target driving speed of the speed control;
determining distance information with respect to a distance of the upcoming signaling unit from the vehicle; and
controlling an acceleration of the vehicle as part of the speed control to reach the target speed based on an acceleration value that depends on the distance information.
